(19) United States
(12) Patent Application Publication
(10) Pub. No.: US 2006/0088076 A1
(43) Pub. Date: Apr. 27, 2006

(54) Operational range designation and enhancement in optical readout of temperature

(76) Inventors: Yoram Lubianiker, Tel Aviv (IL); Lavi Secundo, Tel Aviv (IL); Aharon J. Agranat, Mevaseret Zion (IL)

Correspondence Address: DR. MARK FRIEDMAN LTD.;C/o Bill Polkinghorn, Discovery Dispatch, 9003 Florin Way, Upper Marlboro, MD, 20772, US

(21) Appl. No.: 10/970,985

(22) Filed: Oct. 25, 2004

(51) Int. Cl. G01J 5/00

(52) U.S. Cl. 374/121; 374/133

(57) ABSTRACT

Methods for addressing a designated temperature operational range in a measurement that uses an optical readout of temperature and for enhancing that range are disclosed. The range is enhanced through providing at least one active detector with a periodic response, operative to provide a detector temperature through an electric field-dependent optical readout, and performing at least two measurements of the detector temperature to obtain a non-degenerate reading of an object temperature. The at least two measurements may include three same wavelength/different electric field measurements or two same electric field/different wavelength measurements. The operational range is addressed by using at least one pixel and an associated dummy detector, identifying a center temperature T_{center} of an object temperature range, calculating a pixel temperature T* correlated with T_{center}, calculating an electric field E*, which, once applied to the dummy detector, yields a light intensity reading that is half a maximal intensity value, and optically reading each pixel temperature.

### FIELD OF THE INVENTION

The present invention relates to remote sensing of heat emitted by bodies, namely, the detection of temperature from a distance by optical means. More specifically, the present invention describes methods for addressing a specific operational range and a method for increasing the operational range of the measurement without reducing the accuracy of the reading.

### BACKGROUND OF THE INVENTION

Thermal imaging is a technology that enables to see in the dark. It is based on the infrared (IR) radiation emitted by the objects that comprise a scene. The IR radiation is absorbed by a detector (or many detectors) and measured therein. In some cases, the detector is cooled to cryogenic temperatures to allow the measurement of photocurrent or photovoltage induced by the impinging IR photons. In other cases in which such cooling is not desirable (or considered superfluous), the measurement is based on heat generated at the detector by the impinging IR radiation. In this class of “uncooled” detectors, an absorbing layer (typically made of SiN) transforms the IR radiation into heat. The absorber is thermally coupled to a temperature sensitive element (TSE). The latter is made of a material having a physical property that is temperature dependent. By measuring that property, one can determine the temperature of the TSE, and accordingly the intensity of the IR radiation absorbed by the absorber. The absorbed IR radiation is then used to determine the temperature (and shape, if there is a sufficient amount of detectors to form a picture) of the objects that form the scene.

The most common type of uncooled detectors is the so-called “microbolometer” detector (see e.g. “Uncooled Thermal Imaging. Arrays, Systems and Applications” by Paul W. Kruse, SPIE press, 2002) in which the electrical resistance of the TSE changes with temperature. Recently, we have proposed a new type of uncooled detectors, based on an optical readout of the temperature change of the TSE, see U.S. patent application Ser. No. 10/698463 which is incorporated by reference for all purposes set forth herein. For that purpose we use an electro-optical (EO) material, the birefringence of which is temperature and electric field dependent. The electric field is used to select the specific detector from the (possibly) many detectors along the path of a reading beam.

The most important parameter in assessing the performance of a single detector or an array of detectors is the Noise Equivalent Temperature Difference (NETD). The NETD is the smallest temperature difference between two objects, which are distinguishable by the system. In other words, two objects that differ in temperature by the NETD generate a difference in signal which is equal to the level of noise in the readout. This corresponds to a signal to noise ratio (SNR) of 1. Obviously, a lower value of NETD represents a better quality of the system. The major advantage of our optical reading process, as discussed in U.S. patent application Ser. No. 10/698463, is the suppression of electrical noise associated with the reading. Thus, the optically read detector has a lower value for the NETD than an electrically read detector, i.e. an improved sensing capability.

The NETD parameter refers to temperatures of the objects that comprise the scene. However, in uncooled thermal imaging the temperature of the detector itself is intimately related to the temperature of the objects through the exchange of IR radiation. This correspondence is introduced via a parameter called the Noise Equivalent Power (NEP). The NEP is the difference in the IR radiation power that impinges upon a detector when the temperature of the staring objects differs by the NETD. The NEP yields a temperature change in the detector that is exactly identical to the noise in the temperature of detector, thus representing the SNR value of 1. We hereby define the noise of the detector temperature as “Temperature Fluctuations” (TF). The TF of a detector is thus the extent in which its temperature changes as a result of radiation with a power equal to the NEP. The reader should note that the TF refers to the temperature of the detector itself, and only indirectly (through radiation exchange) to the temperature of the objects. Obviously, a low value for the TF enables high thermal sensitivity of the measurement.

Another parameter, which is often at odds with the TF (and correspondingly with the NETD), is the operational range of the sensing. The operational range represents the temperature interval from which values can be read accurately by the detector. If the temperature of a certain object is higher than the upper limit of the operational range, then the current bolometric system will register its value as the saturation level. Correspondingly, if its temperature is below the lower limit of the operational range it will be registered by the same system at a level of zero. In either case the system will not be able to inform the user that values that are essentially out-of-scale have been registered, let alone provide any information in that temperature range. A schematic description of the readout values of such a bolometric system is presented in FIG. 1. A full line 102 represents a case of a limited operational range with a high sensitivity. A dashed line 104 represents a case of an extended operational range with a lower sensitivity. The operational range is the fraction of the X axis for which the Y axis values are higher than zero but lower than 1 (or the full scale value).

The reason for the conflict between the TF/NETD and the operational range is quite straightforward: the reading of the detector's temperature is transformed into a digital signal, using an analog to digital (A/D) converter. The A/D is characterized by the number of possible output states it can produce. For example, a 12 bit A/D converter has 2¹² (=4096) different states. It stands to reason to set the least significant bit resolution as equivalent to the TF/NETD. In such a case two objects, the temperature of which differs by the NETD value, will be identified as different objects (by a single bit) by the A/D converter. Had the single bit stood for a temperature difference larger than the NETD, we would not have taken advantage of the low level of noise the system enabled. On the other hand, had the single bit stood for a temperature difference smaller than the NETD, we would have “wasted” bits, since the signal would have been too noisy (i.e., the single bit would not have been informative). When the bit is equivalent to the NETD value, the operational range is equal to the number of bits times the NETD. For example, with a NETD value of 30 mK and a 12 bit resolution the full scale is ˜125 degrees.

The only way to allow a larger operational range (using the same number of bits) is by assigning a larger temperature difference for each bit. For example, if our system requires an operational range of 500 degrees, we can achieve that only by assigning a temperature difference of 120 mK per bit (assuming we cannot use a higher resolution A/D converter). In such a case, the effective NETD will be 120 mK, even though the system enables in principle better thermal resolution. The user is therefore left with the unpleasant choice between the quality of the performance and the operational range in which the thermal detector is of service. FIG. 1 demonstrates this reality through dashed line 104, which represents a higher operational range than full line 102. Since for the same interval of Y values we have a larger range of X values, and since the resolution of Y values is the same for both curves, it inevitably follows that each bit will represent a larger temperature interval.

Another disadvantage of the microbolometer detector is the lack of flexibility in the definition of the operational range. In uncooled detectors it stands to reason to stabilize the detector to room temperature, thus minimizing the power consumption. This imposes a restriction on the readout, i.e., objects that are at room temperature will yield a readout value that is half the full scale. This is because the resistance measurement is performed with respect to a reference detector, which is at room temperature. The system essentially measures deviations of the pixel resistance from the value of the reference. Let us consider a user that uses the thermal detector for measuring the temperature within a furnace. The temperatures of the furnace are between 100 and 225 degrees, so the overall operational range is 125 degrees. While this coincides with the magnitude of the operational range discussed above, there is nevertheless a problem. Since room temperature is not within the operational range (let alone in the middle of operational range), the readings are restricted to a fraction of the 12 bit span the system provides. Specifically, if room temperature is 25 degrees, then the system is required to cover the entire range of (−175) to (225) degrees, i.e. a operational range of 400 degrees with an NETD value of 95 mK instead of 30 mK. In practice many of the readings the system enables will never happen, since the scene is limited to the range of 100-225 degrees.

There is therefore a need for, and it would be advantageous to have a method for enhancing the operational range in an optical temperature measurement without affecting the measurement sensitivity. It would be further advantageous to be able to shift the operational range to any set of temperature values, while using a single measurement and maintaining a low NETD value.

### SUMMARY OF THE INVENTION

The present invention discloses a novel reading scheme, which enables an enhancement of the operational range without essentially affecting the NETD value, while maintaining the same A/D converter resolution. This scheme is applicable to the novel thermal detectors that utilize an optical readout mechanism disclosed in U.S. patent application Ser. No.10/698463. In the optical readout device disclosed therein, the signal is not a monotonic function of temperature. Instead, it is a periodical function (specifically, sinusoidal), the frequency of which depends on the electric field that is used to trigger the reading. When the electric field is large the frequency is high, and one obtains a high thermal resolution. When the electric field is low, one obtains a low frequency and a lower thermal resolution. In order to measure a high operational range at a high resolution, we perform several (in a preferred embodiment three) scans with high and low fields. In the high field scan, which enables the high thermal resolution, we have several possible temperatures corresponding to each optical readout value (i.e. a degeneracy in temperature reading). The low field scans are used to remove that degeneracy, and to correctly assign the right temperature for each readout.

The present invention also discloses a method for the addressing of an operational range for temperature measurement using the optical readout. That is, the present invention enables the usage of a single reading that maintains the low NETD value, while enabling to shift the operational range to any set of temperature values.

According to the present invention there is provided method for enhancing the operational range in an optical temperature measurement, comprising the steps of: providing at least one active detector operative to perform a temperature measurement, said detector having a response that is a periodic function of temperature, and performing at least two measurements of the detector temperature to obtain a non-degenerate reading of the temperature of the object, whereby the method provides a unique and accurate temperature measurement in an enhanced operational range and with high sensitivity.

According to one feature in the method for enhancing the operational range in an optical temperature measurement, the step of providing at least one active detector includes providing a detector operative to provide a detector temperature through an electric field-dependent optical readout,

According to another feature in the method for enhancing the operational range in an optical temperature measurement, the step of providing at least one active detector includes providing a detector with an EO material layer characterized by an index of refraction, the index of refraction changeable under application of the electric field.

According to yet another feature in the method for enhancing the operational range in an optical temperature measurement, the step of providing at least one active detector further includes providing a dummy detector associated with each active detector.

According to yet another feature in the method for enhancing the operational range in an optical temperature measurement, the step of performing at least two measurements includes performing a low resolution scan and a high resolution scan using only the active detector, and performing a high resolution scan using both the active detector and its associated dummy detector. The low-resolution scan uses a weak electric field and the high resolution scan uses a stronger electric field.

According to yet another feature in the method for enhancing the operational range in an optical temperature measurement, the step of performing at least two measurements includes applying an electric field to each active detector, optically reading each active detector temperature using a first wavelength light source, and optically reading each active detector temperature using at least one different wavelength light source. The optical reading may be performed simultaneously.

According to yet another feature in the method for enhancing the operational range in an optical temperature measurement, the step of performing at least two measurements includes obtaining two high-resolution scans by applying two different intermediate electric fields to each active detector, and optically reading each active detector temperature using a predetermined wavelength light source. In this case, there is no use of the serial dummy.

According to the present invention there is provided a method for addressing a designated temperature operational range in a temperature measurement comprising the steps of: providing a detector array comprising a plurality of pixels, each pixel associated with a serial dummy detector and operative to provide a pixel temperature through an electric field-dependent optical readout, using each dummy detector to obtain a specific readout for the temperature that lies in the center of a desired temperature range, and optically reading each pixel.

According to the present invention there is provided a method for addressing a designated temperature operational range in a measurement that uses an optical readout of temperature, the optical readout performed with least one pair of a pixel and a serial dummy detector, the method comprising the steps of: calculating a temperature T* of each pixel, calculating an electric field E* that adjusts a readout intensity scale to half maximum when applied to the dummy detector, and optically reading each pixel temperature.

According to one feature in the method for addressing a designated temperature operational range of the present invention, the step of optically reading each pixel temperature includes applying an electric field to each pixel simultaneously with applying E* to its associated dummy detector.

### BRIEF DESCRIPTION OF THE DRAWINGS

FIG. 1 is as schematic description of the readout values in microbolometer thermal detectors.

FIG. 2 is a schematic description for a basic detector that utilizes an optical readout (prior art);

FIG. 3 is a schematic description of a crossed-polarizers configuration for reading a detector output (prior art);

FIG. 4 is a schematic description of a Mach-Zehnder Interferometer (MZI) configuration for reading a detector output (prior art);

FIG. 5 shows schematically readout values under high (full line) and low (dashed line) electric fields;

FIG. 6 shows in a flow chart an embodiment of the method for operational range designation in an optical readout of temperature;

FIG. 7a shows schematically readout values for a temperature range around room temperature and for a range of elevated temperatures;

FIG. 7b shows schematically readout values for a range of elevated temperatures, with a phase shift induced by an electric field applied to a serial dummy;

FIG. 8 shows a flow chart of a first embodiment of the method for operational range enhancement according to the present invention;

FIG. 9 shows a flow chart of a second embodiment of the method for operational range enhancement according to the present invention;

FIG. 10 shows the readout values for two scans using the embodiment of FIG. 9.

### DETAILED DESCRIPTION OF THE PREFERRED EMBODIMENTS

The present invention discloses a method for operational range designation and enhancement in an optical readout of temperature in thermal detectors and thermal imagers. In order to better understand the method of the present invention, reference is first made to the basic preferred embodiments of the IR detector with optical readout described in more detail in U.S. patent application Ser. No. 10/698463.

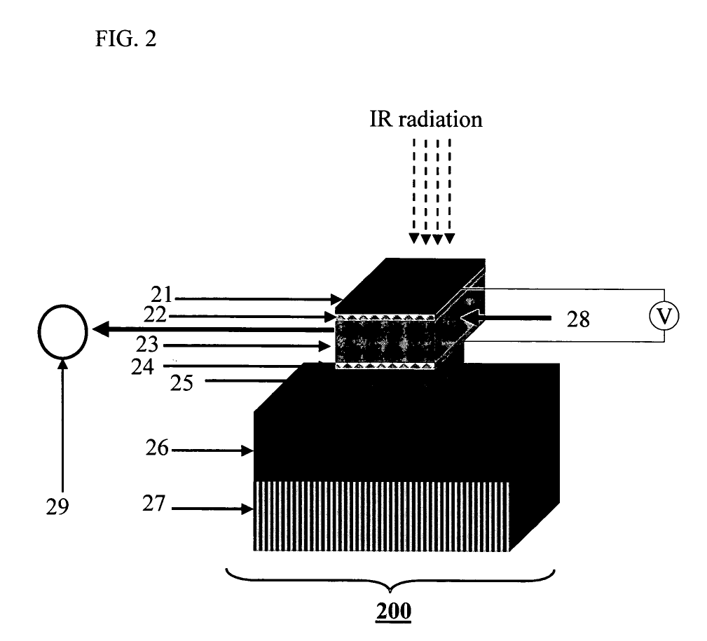

FIG. 2 shows a schematic description of the most basic embodiment of the thermal detector disclosed therein. An object (not shown) produces IR radiation that impinges upon a detector 200. Detector 200 comprises an absorbing top layer 21 and a thermally sensitive element (TSE) 23, in the form of a thin layer made of an electro-optic (EO) material with temperature dependent optical properties, in particular a temperature dependent index of refraction. Top layer 21 has a high absorption coefficient for IR radiation, high thermal conductivity and a low thermal capacity, and is used to transform the IR radiation to heat, which is transferred to thermally sensitive element 23. The index of refraction of element 23 changes under the application of an electric field. Element 23 is sandwiched between a top electrode 22 and a bottom electrode 24, the electrodes enabling the application of the electric field from a source V, the electrodes and source V thus comprising an electrical mechanism for inducing a change in the index of refraction of element 23. The extent of the change in the index of refraction depends on the temperature of element 23, and in particular on the IR radiation absorbed in layer 21.

All these layers are located on top of a thermal link 25, which is connected to a thermally conducting substrate 26 and a temperature controller 27. Controller 27, e.g. a Thermo-Electric Cooler (TEC), enables us to treat substrate 26 as a heat sink. Thermal link 25 must have a high thermal resistivity, to enable a significant temperature difference between substrate 26 and element 23. Element 23 is further characterized by having a low thermal resistivity, so that its temperature is uniform, and it can be viewed as a heat capacitor.

Having defined the structure of the thermal detector, we now turn to the optical reading mechanism of the temperature change through a laser beam 28. The beam propagates through the EO material (element 23), so the latter must therefore be transparent to the wavelength of the laser. The application of an electric field changes the index of refraction tensor of EO material 23. The magnitude of this change is a function of the temperature increase induced by the incident IR radiation. These changes affect the properties (e.g. phase or state of polarization) of the laser beam that propagates through the EO material. The change in these properties is then measured through its effect on the light intensity using a power meter 29 (FIG. 2), which is another element of the optical reading mechanism. It should be noted that additional optical elements are required to enable the transformation of the change in the optical properties of the beam into light intensity dependence. Consequently, the intensity of the IR radiation can be determined through the measurement of the light intensity of the reading beam.

U.S. patent application Ser. No. 10/698463 discloses two major configurations in which the temperature can be read through the measurement of the light intensity. The first configuration is based on crossed polarizers, while the second configuration utilizes a Mach-Zehnder Interferometer (MZI).

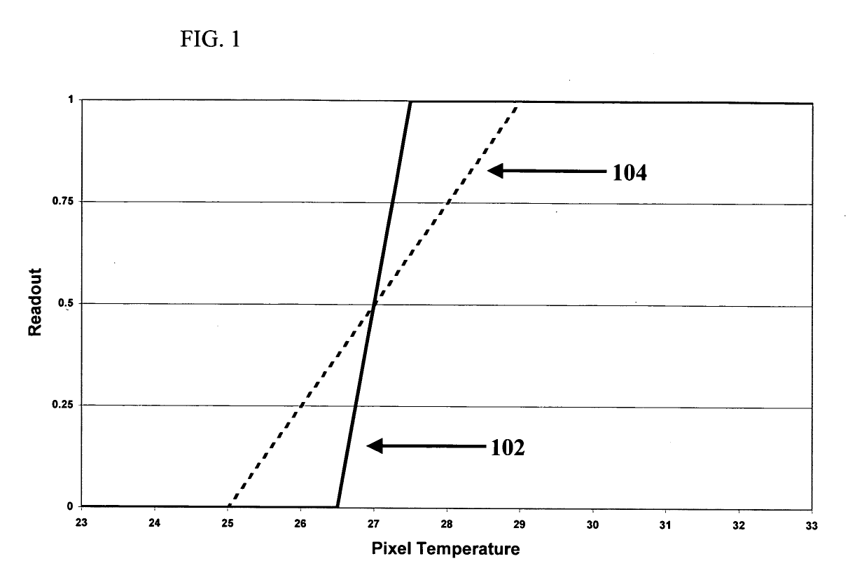

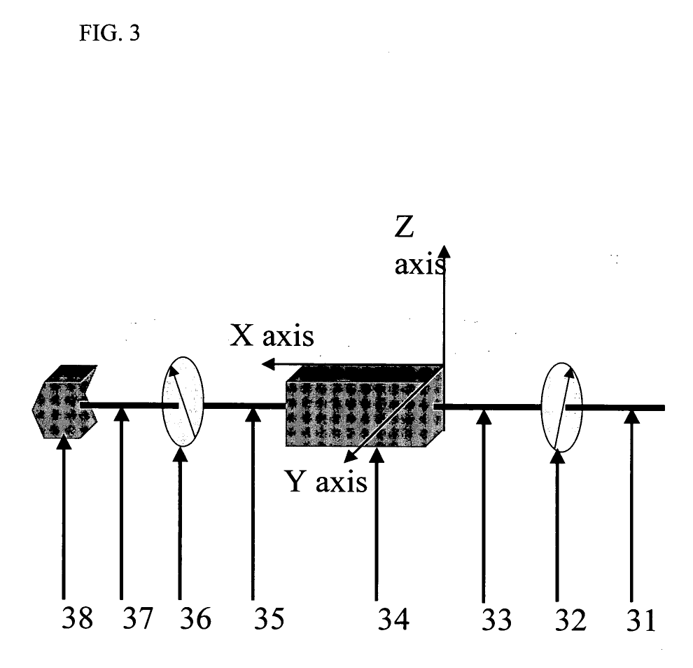

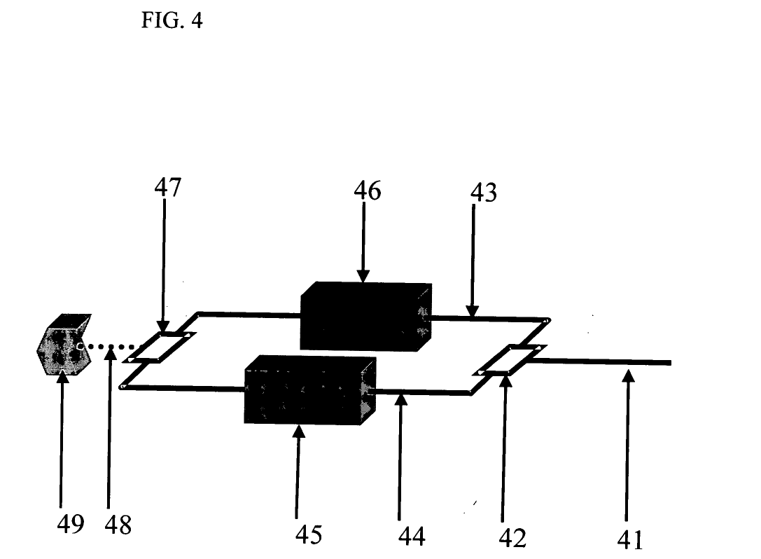

The crossed polarizers configuration is shown schematically in FIG. 3. For the simplicity of the presentation, the thermal detector of FIG. 1 has been reduced here (and in FIG. 4) to an EO layer 34. We start by defining a set of coordinates: we denote by Z the axis perpendicular to the electrodes of the EO material, by X the axis of the laser beam propagation, and by Y an axis perpendicular to both Z and X. The Z-Y plane defines a facet of EO layer 34 on which the laser beam 33 impinges, whereas the X-Y plane defines a facet on which the IR radiation impinges. In the general case in which the X-Y facet is rectangular, the rectangle has a length dimension (along X) L. The laser beam is applied perpendicularly to the Z-Y plane facet, along a “length axis” of the EO layer that coincides with X, thus traversing the EO material along its length dimension L. This means that the state of polarization of the beam is then defined within the Y-Z plane.

We now place crossed linear polarizers along the beam path, a first polarizer 32 in front of the detector (EO material 34), and a second polarizer (“analyzer”) 36 behind it. First polarizer 32 is set at 45° to the Z axis, so that the Z axis and Y axis components of beam 33 that reaches EO material 34 are equal. The light intensity, which is read at a power meter 38, is a direct measurement of the level of birefringence of the EO component of the detector. In the simplest case, the EO material is isotropic in the absence of an electric field. In this case, the polarization of a beam 35 emerging from EO material 34 is the same as that of beam 33 entering this material, so that the light intensity of the beam 37 that emerges from the analyzer and reaches power meter 38 is zero. This is because the analyzer is rotated by 90° with respect to the first polarizer.

Once the electric field is turned on, the index of refraction in the Z direction deviates from the one in the Y direction due to the EO effect, to an extent that is temperature dependent. We denote this difference by Δn. As a result, there is a phase difference φ between the (equal intensity) Y and Z components of the electromagnetic wave, given by:

$$ϕ = \frac{2 \cdot π \cdot L}{λ} Δ n \qquad ( 1 )$$

where L is the length of the EO material (in the X direction) and λ is the wavelength of the reading beam 33. The polarization of beam 35 that emerges from the EO material is not necessarily linear, and thus the light intensity measured at power meter 38 is not necessarily zero. In fact, it is given by:
I(φ)=I₀{1+sin(2φ)}=I₀ cos²φ (2)
where I₀ is the intensity of the laser (assuming no losses along the optical path of the beam). Hence, the measured light intensity is a function of Δn, which by itself is a function of temperature, as explained above. Thus, the temperature of the EO material is measured via the light intensity measured at the power meter. The object temperature can then be deduced from the EO material (or pixel) temperature, see e.g. “Uncooled Thermal Imaging: Arrays, Systems and Applications” by Paul W. Kruse, SPIE press, 2002 above.

For the convenience of the measurement it is advisable to add a serial dummy to the path of the reading beam. As discussed in patent application Ser. No. 10/698463, the serial dummy is an electro-optical component identical to the detector, except that the dummy is insensitive to IR radiation through the absence of the absorbing layer 21. Through the application of an electric field across the serial dummy we can induce an IR independent phase shift—an added term to φ. This will correspondingly effect I(φ), thus allowing flexibility in assigning output values to any given IR input.

The MZI configuration is shown schematically in FIG. 4. The basic configuration includes an active detector 45 (or simply “detector”) and a dummy detector 46 (referred to henceforth simply as the “dummy”). Again, the dummy is generally identical to the active detector in all elements except for a missing top IR-absorbing layer (i.e. layer 21, FIG. 2). This makes the dummy totally insensitive to IR induced temperature changes. A laser beam 41 is polarized along the Z-axis, and a beam splitter 42 is used to divide the beam into two beams of preferably equal intensity, a reference beam 43, and a reading beam 44. The reading beam propagates through EO material 45, while the reference beam propagates through dummy 46. The two beams are then brought to interfere (e.g., by a beam combiner 47), and a resulting single beam 48 is measured at a power meter 49. The light intensity at that point depends on the phase difference between the two branches. This phase difference originates from the difference in optical path length of the two branches. If the branches are made of identical physical length, the phase difference originates solely from the difference in index of refraction between the detector and the dummy. As explained above, the latter is a simple function of the temperature difference, and can thus be used to determine the intensity of the IR radiation that impinges upon the detector.

The invention in U.S. patent application Ser. No. 10/698463 is applicable to both single detectors (used for thermometry, i.e., the determination of temperature without any reference to the shape of the object) and to a plurality of detectors that form an array of “active” detectors or pixels (used for full thermal imaging). The present invention is also applicable for both single detectors and detector arrays. However, for the sake of simplicity, we shall hereafter refer to pixels only. The case of a single detector may be viewed as a degenerated case of an array. The dummy is described henceforth as being “associated” with a pixel. This association may involve one dummy for each pixel, or one dummy for a plurality of pixels (e.g. a pixel row in an array), as described in detail in U.S. patent application Ser. No. 10/698463.

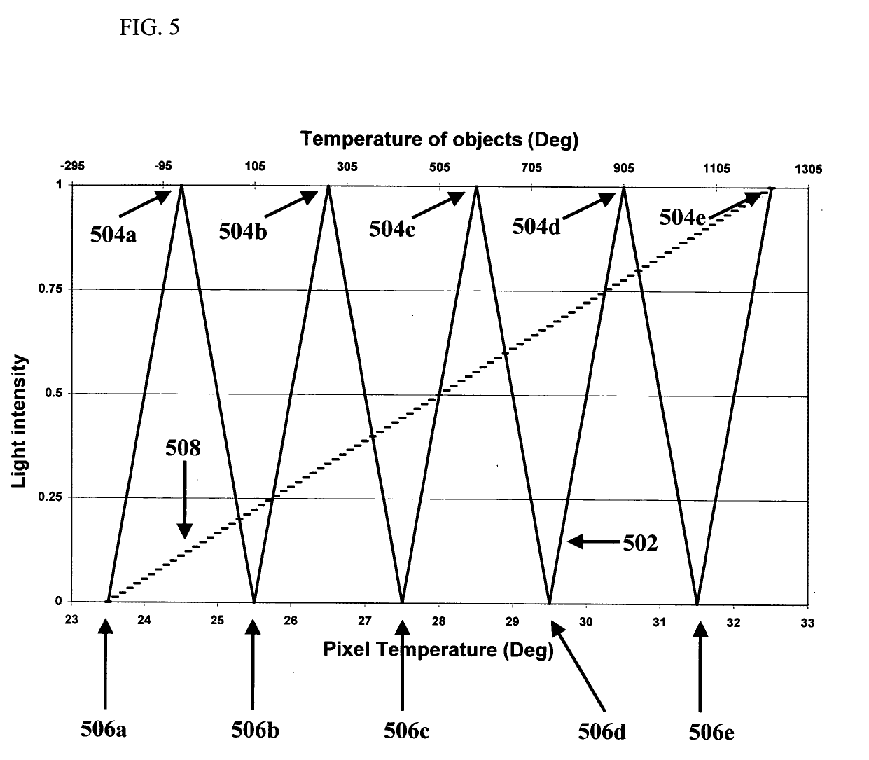

An important feature of both the crossed polarizers and the MZI configurations is that the reading has a periodical temperature dependence, specifically a sinusoidal dependency, as seen in Eq. (2). This is quite different from a bolometer detector, in which the resistance is a monotonic function of temperature. This difference lies at the heart of the current invention. For the sake of simplicity, we will assume from now on that the temperature dependence of the light intensity in our optically read thermal detector is of a “triangular” shape (used as an exemplary stand-in for the squared sine of Eq. (2)), as shown schematically by a full line 502 in FIG. 5. The intensity is normalized and shown as a function of temperature. Line 502 extends over a pixel temperature range of 23.5 to 32.5 degrees, and includes 5 maxima points 504a-e and 5 minima points 506a-e.

Another important feature of both configurations is that the electric field applied to enable the reading process defines the extent of change in the index of refraction, Δn, through the EO effect, as described in detail in U.S. patent application Ser. No. 10/698463. Since Δn defines the phase φ, it follows that the electric field determines the slope of the triangular shape and its period. Thus, if the periodic intensity shown by line 502 represents a strong electric field, a weak field will be represented by a line with a much smaller slope, e.g. dashed line 508. Line 508 shows in effect only one half of a cycle, instead of the 4.5 cycles shown by line 502. The method of the present invention is applicable equally well to either configuration discussed above.

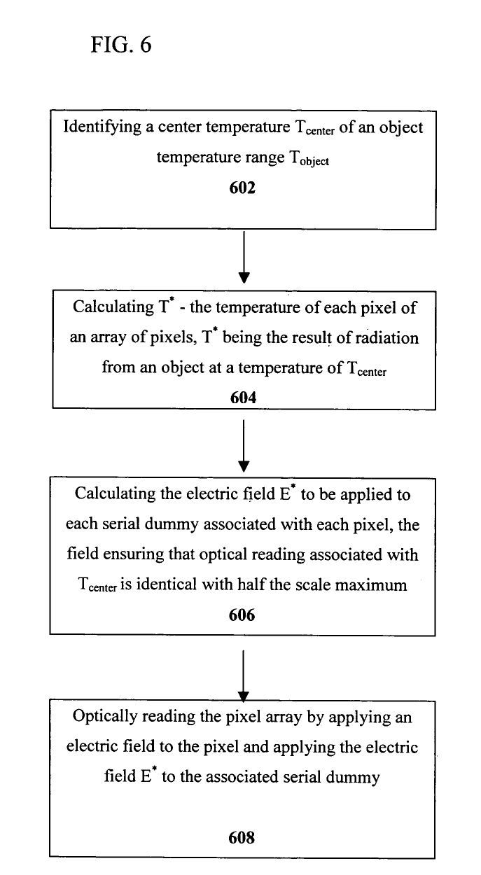

In one embodiment, the method for addressing a designated operational range in an optical readout of temperature is summarized schematically in a flow chart in FIG. 6. The method includes identifying a center temperature T_{center} of an object temperature range in step 602; calculating T*−the temperature of each pixel that is exposed to radiation from an object with a temperature of T_{center} in step 604. Note that T* depends on the temperature of heat sink 26 in FIG. 2; calculating an electric field E*, which, once applied to a serial dummy associated with each pixel, will yield a light intensity reading that is half of the maximal value of the light intensity in step 606; and optically reading each pixel temperature in step 608. The optical reading includes the application of an electric field to each pixel simultaneously with the application of E* to the associated dummy. In order to read the entire array of pixels, the process is performed simultaneously for a row of pixels (each with its own serial dummy), and proceeds row by row to yield the full thermal image of the object. This embodiment is now described in more detail.

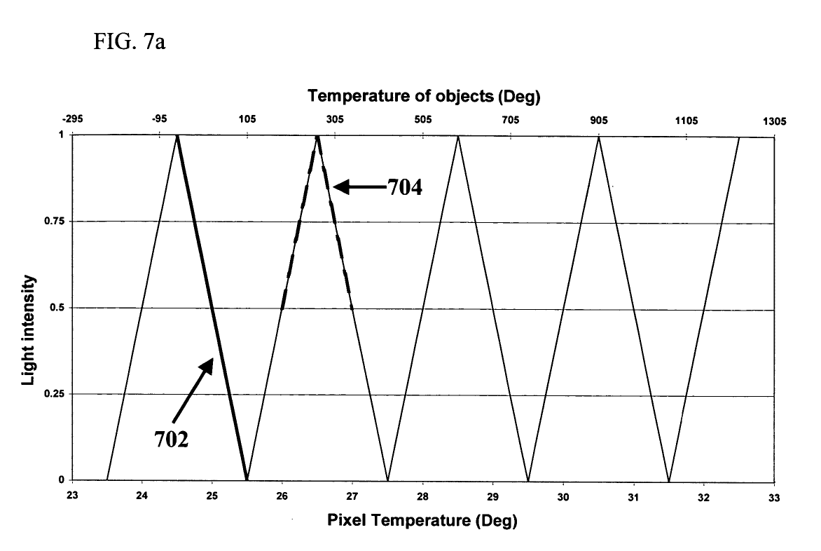

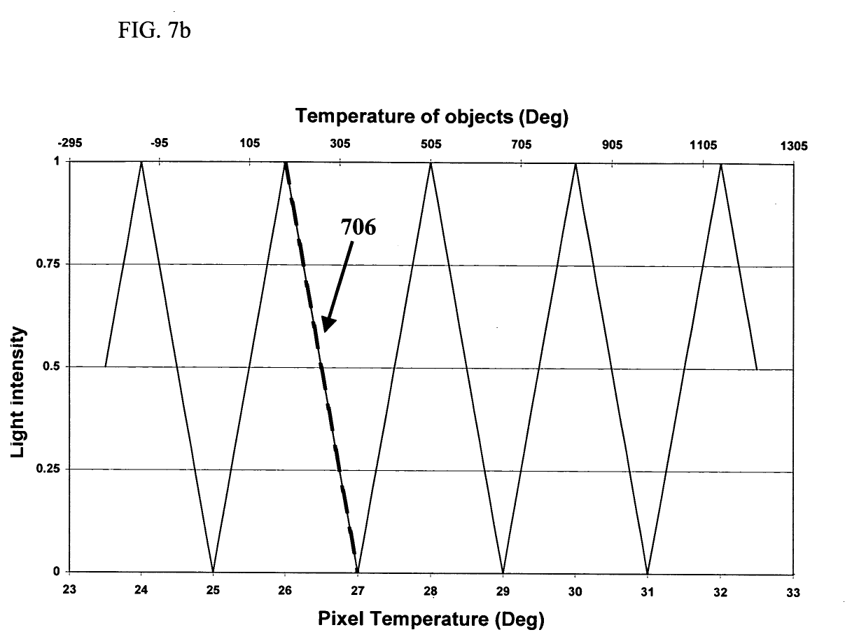

Let us assume that a thermal imaging system needs to detect objects with temperatures T_{object} between −55 and 105 degrees, i.e., a operational range of 160 degrees, centered around T_{center}=25 degrees. For simplicity, let us assume that the heat sink is stabilized to 25 degrees, which means that the pixel temperature T* is also equal to 25 degrees. In extreme cases, we find that the temperature of the pixel can drop to 24.5 or rise to 25.5 if the pixel stares at objects with T_{object} of −55 and 105 degrees, respectively, i.e., at the edge of the operational range. The extent of the heating and cooling of the pixel is determined via a large number of parameters, and particularly the thermal resistor that connects the pixel and the heat sink. The values stated above reflect realistic results of such a calculation. The reader may find information on this calculation in the book by Kruse cited above. This situation is presented in FIG. 7a, by the full line 702.

Lets us now see what happens if the same system is required to detect objects with temperatures in the range of 185 to 345 degrees, quite far from the temperature of the heat sink. Now T_{center} is 265 degrees, and correspondingly T* is equal to 26.5 degrees. Without changing any other parameter, the I(T) function in this case does not represent a one-to-one correspondence, as can be seen by a thick dashed line 704 in FIG. 7a. However, by merely changing the electric field E* across the serial dummy, we can shift the entire phase of the output, reaching the state shown in FIG. 7b, where the same temperature range can be read properly, as marked by the dashed line 706. This change in the electric field is essentially repeating step 606 of FIG. 6 under the new circumstances. Note that here, unlike in microbolometer detectors, the new temperature range will be read without any harm to the sensitivity of the reading. This benefit is a consequence of the periodical nature of the optical readout.

We add, in passing, that the case of a “shifted” operational range presented above can also be addressed differently, without the change of E*. The temperature of the heat sink can be altered to bring T* to a value that yields a readout which is half the scale maximum (e.g., 26 degrees). However, such a method is not desirable, as it requires power consumption, and the time required for stabilizing the heat sink to the new temperature may be long.

In some cases, there is a desire to extend the operational range, e.g. beyond the 160 degrees range used above. One way to achieve this goal is to reduce the electric field to the level represented by the dashed line 508 in FIG. 5. In such a case we can set an operational range that extends from the absolute zero (corresponding to a pixel temperature of 23 degrees) up to the temperature of 1225 degrees (as in FIG. 5) or up to the temperature of nuclear fusion. Consequently, the thermal sensitivity will be reduced. Advantageously, the present invention allows an expansion of the operational range without a consequent reduction in sensitivity (or simply “operational range enhancement”) as explained below.

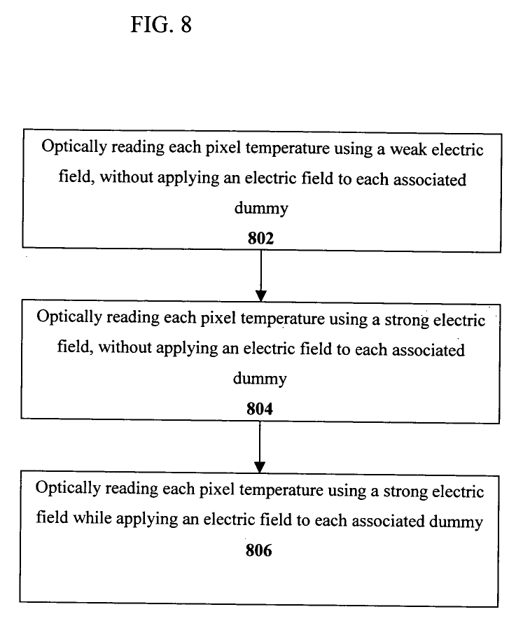

The method for operational range enhancement is based on a multiple reading sequence, in which both weak and strong electric fields are used for the optical reading of the temperature. The main steps of a first preferred embodiment, also referred to henceforth as a “different field/same wavelength” embodiment, are shown schematically in a flow chart in FIG. 8. The steps include: optically reading the temperature of the pixel using a weak (“low”) electric field, without applying an electric field to any associated serial dummy in step 802 (“low resolution scan”), optically reading each pixel temperature using a strong (“high”) electric field, without applying an electric field to any associated serial dummy in step 804 (“high resolution scan”), and optically reading each pixel temperature using the same strong electric field as in 804 while applying an electric to the associated dummy in step 806. The field applied to the dummy is typically different than the one applied to the pixel.

In the context of the present invention, a “high” field is defined by the ability to reach the desired sensitivity, i.e. 1 bit=TF or 1 bit=NETD (in terms of the “inner (pixel)” and “outer (object)” worlds). Typical values differ according to the EO material used as the TSE. For KLTN, a typical high field is about 3000 V/cm. A “low” field is determined by the required operational range, so that the I(T) function will be monotonic throughout the entire operational range. Preferably, this field also covers the entire spectrum of possible light intensities, from zero to the maximal possible value. The optical reading processes of steps 802 and 804 do not require the application of an electric field to the serial dummy, as done in step 606 above. The application of multiple readings renders the readout value that corresponds to T_{center} irrelevant, since the operational range is no longer limited to an interval around T_{center}.

To demonstrate how the multiple reading process works, let us assume that our system has a 15 bit resolution A/D converter, and its NETD value is 5 mK. Assuming we operate at the optimal level of sensitivity (i.e., 1 bit equals to the TF/NETD values), this corresponds to an operational range of ˜160 degrees. We further assume that for a specific application, an operational range of 1440 degrees is required (or, in more general terms, M times larger than the high resolution operational range, M=9 for this example). With the options discussed above (up to and including FIG. 7) it is not possible: to obtain the high operational range with a high sensitivity. In the preferred embodiment above (FIGS. 6, 7), we can either use the high electric field (line 502 in FIG. 5) and obtain a low operational range with a high sensitivity, or we can use the low field (line 508 in FIG. 5) and obtain the full operational range but with a resolution 9 times higher than the NETD value (M times higher in the general case). In contrast, the present invention allows us to use the 15 bit ADC in the required operational range without sacrificing sensitivity (thermal resolution).

As described in FIG. 8, the reading process is done first under a low electric field applied just to the pixel (i.e. step 802, with no field applied across the serial dummy). The measured I(T) value yields the temperature with a M*5 mK resolution. Since we wish to obtain a 5 mK (M times better) resolution (i.e., the best value we hope for, considering the level of noise), we essentially have M possible values of temperature, which are degenerated. These values are adjacent to one another, i.e., lie within a single temperature interval with size M*5 mK. In order to remove this degeneracy, we now perform a high resolution scan, i.e., repeat the reading process under a high electric field (step 804). Again, this is done without applying the electric field to the serial dummy. Under the new conditions, each of the M temperature values belonging to the same M*5 mK interval yield a different reading, thus removing the previous degeneracy of step 802. However, a new degeneracy has been formed, since now, for each light intensity value there are exactly M corresponding temperature values (now entirely different of each other). In a simple case in which the reading (under the high electric field) is exactly half the full scale of possible light intensities (half the maximum reading), the new degenerated values are evenly spaced in the entire operational range. For M=9, these values are spaced 160 degrees apart. Since there is no overlap between the degenerated values in the first (step 802) and second (step 804) reading, we are able to identify the two readings with a single temperature value.

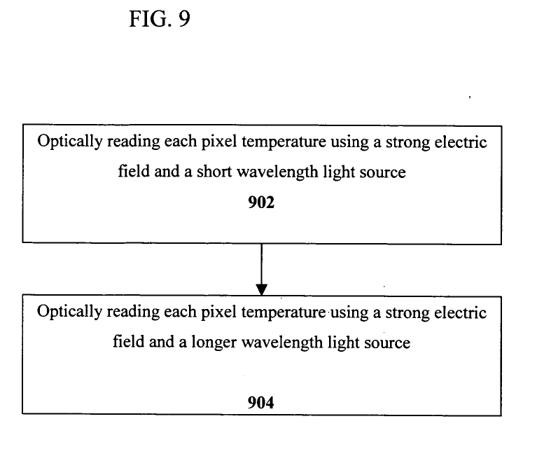

It is noteworthy, however, that the degeneracy in readings has not been fully removed with these two readings. Specifically, if the I(T) value is very close to the zero level or to the maximal level, there is still a two-fold degeneracy left. Here, “very close” means a value within M/2 bits from zero or from the maximal reading. A third scan (step 806) is required in order to remove this degeneracy. To achieve this, we apply to the pixel the same electric field as in step 804, but now also apply an electric field across the serial dummy, so that a phase shift (of, e.g., by 45 degrees) is induced. This will “push” the problematic I (T) values away from the extreme values (zero and maximum), into the range where no degeneracy problems exist. Therefore, in order to fully remove any degeneracy, 3, and no more than 3 readings are required in the “different field/same wavelength” embodiment regardless of the exact value of M. It is therefore possible to obtain as high an operational range as required without limiting the thermal resolution of the system. The order of the 3 readings is not important, and that steps 802-806 can be interchanged. For example, step 804 may be performed first, followed by 806 and then 802. In other words, the embodiments of the method of the present invention as shown in FIG. 8 and later in FIG. 9 are order insensitive. Note that in some cases, e.g. when a smaller operational range is satisfactory, less than 3 readings (and even a single one) may be enough to uniquely determine the temperature, e.g. as in the basic embodiment of FIG. 6.

In the embodiment of FIG. 8, we use a strong electric field scan to remove the degeneracy between different temperature values that yield the same readout under weak electric field conditions. A second embodiment of the method for operational range designation and enhancement in optical readout of temperature of the present invention is shown in a flow chart in FIG. 9. This embodiment is also referred to as a “same field/different wavelength” embodiment. It comprises a plurality of scans (preferably two) that use the same electric field, but a different wavelength of the readout beam. This embodiment does not require the usage of a serial dummy. More generally, this embodiment employs a plurality of scans, all with the same electric field but different readout beam wavelengths.

As can be seen in Equation (1) above, the wavelength of the readout beam affects the phase φ, which in turn determines the light intensity readout. By using at least two different wavelengths, we essentially obtain the same effect as in the case of using different electric fields with a single wavelength. As described in FIG. 9, we apply first in step 902 an electric field to the pixel being read. We preferably utilize a high electric field and a short wavelength source, in order to enhance the sensitivity of the measurement. In step 904 we repeat the measurement under the same electric field, but using a light source with a longer wavelength. It is important to note that the two reading steps can be performed simultaneously, if the power meter 29 (FIG. 2) can differentiate between colors, as some CCD detectors can. Another important point is that the “same field/different wavelength” embodiment can be combined with the “different field/same wavelength” embodiment described above. For example, it is possible to do the third readout (step 806) of the “different field/same wavelength” with a different light source and forfeit the usage of a serial dummy. Alternatively, an embodiment may use only two scans of a “different field/same wavelength” configuration, as described in more detail below.

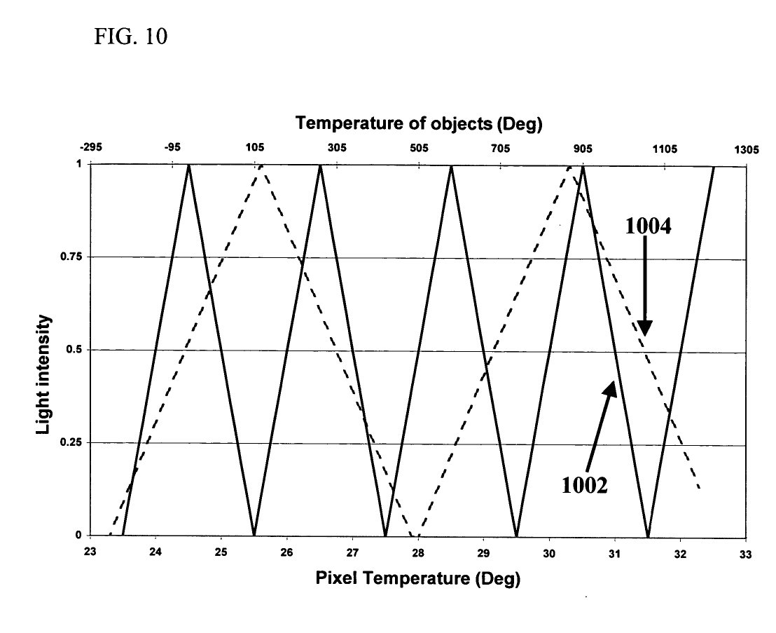

To demonstrate the operation of the “same field/different wavelength” embodiment, we show schematically in FIG. 10 the readout values for the two scans. The first scan, marked by a full line 1002, represents rapid changes of light intensity with temperature. This is a consequence of the usage of a short wavelength and a high electric field. The second scan, marked by the dotted line 1004, is more slowly changing, due to the use of a longer wavelength. In the preferred embodiment, the two wavelengths are chosen so that the maximum and minimum points of their respective readouts will not coincide. For example, if the second wavelength were just double the first wavelength, then the maximum of the second readout would overlap with every other maximum of the first readout, leaving us short of information in that range. Therefore, preferably the second wavelength should not be an integer multiple of the first wavelength. We emphasize that again the steps of this embodiment are interchangeable in order.

Finally, it is possible to perform a high-resolution scan over the entire operational range with only two scans using a “different field/same wavelength” configuration. The same I (T) plots of FIG. 10 can be obtained by keeping the same short wavelength but changing the electric field. Unlike the embodiment plotted schematically in FIG. 5, here we do not use a “weak” electric field. Rather, we use an intermediate field, to obtain curves identical to those of FIG. 10. For example, in KLTN in the paraelectric phase, the dependency of Δn on the electric field is quadratic (see U.S. patent application Ser. No. 10/698463). Therefore, instead of using two scans under a strong electric field of E₁ utilizing wavelengths of λ₁ (a short wavelength) and λ₂ (a longer wavelength), we can use two scans under electric fields of E₁ and E₂ utilizing a single wavelength of λ₁. The I(T) plots will be the same as in FIG. 10, provided that

$${E}_{2} = {E}_{1} * \sqrt{\frac{{λ}_{1}}{{λ}_{2}}} .$$

In order to emphasize the importance and advantages of the present invention, let us look again at the electronic reading process of the microbolometers: Suppose that a system is required to operate in a operational range that is M times larger than the one defined by the NETD multiplied by the number of available bits. The only way to do that is to use an oversampling algorithm. This means that the number of readings per pixel must be 2^{M}, in contrast with a single reading required in the trivial reading process. Even for M=4, this requires an A/D converter with a speed which is 16 times higher than the one required for a trivial reading process. On the other hand, using our invention, a mere factor of 2-3 in speed is required for the improved sensitivity, and that number is independent of M.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A method for enhancing the operational range in an optical temperature measurement, comprising the steps of:
a. providing at least one active detector operative to perform a temperature measurement, said detector having a response that is a periodic function of temperature; and
b. performing at least two measurements of said detector temperature to obtain a non-degenerate reading of the temperature of the object, whereby the method provides a unique and accurate temperature measurement in an enhanced operational range and with high sensitivity.

2. The method of claim 1, wherein said step of providing at least one active detector includes providing a detector in which said temperature measurement is obtained with an electric field-dependent optical readout;

3. The method of claim 2, wherein said step of providing at least one active detector further includes providing a detector with an electro-optic (EO) material layer characterized by a temperature-dependent index of refraction, wherein said index of refraction is changeable under application of said electric field.

4. The method of claim 3, wherein said step of providing at least one active detector further includes providing a dummy detector associated with said active detector.

5. The method of claim 4, wherein said performing at least two measurements includes:
i. performing a low resolution scan using only said active detector;
ii. performing a high resolution scan using only said active detector; and
iii. performing a high resolution scan using both said active detector and said associated dummy detector.

6. The method of claim 5, wherein said performing a low resolution scan using only said active detector includes optically reading each said active detector using a weak electric field, wherein said performing a high resolution scan using only said active detector includes optically reading each said active detector using a stronger field than said weak electric field, and wherein said performing a high resolution scan using both said active detector and said associated dummy detector includes optically reading each said active detector temperature while applying the same said stronger electric field to said active detector while simultaneously applying a different electric field to said associated dummy detector.

7. The method of claim 5, wherein the order of said three measurements is interchangeable.

8. The method of claim 4, wherein said step of providing at least one active detector includes providing an array of said active detectors, whereby the method can provide a thermal image of said object.

9. The method of claim 1, wherein said step of performing at least two measurements includes:
i. applying an electric field to each said active detector,
ii. optically reading each said active detector temperature using a first wavelength light source, and
iii. optically reading each said active detector temperature using at least one different wavelength light source.

10. The method of claim 9, wherein said applying an electric field includes applying a strong electric field, thereby obtaining a high measurement sensitivity, wherein said using a first wavelength light source includes using a light source with a short wavelength, and wherein said using at least one different wavelength light source includes using at least one light source with a wavelength longer than said first wavelength.

11. The method of claim 9, wherein the order of said at least two measurements is interchangeable.

12. The method of claim 9, wherein said steps of optically reading are performed simultaneously.

13. The method of claim 1, wherein said step of performing at least two measurements includes:
i. obtaining two high resolution scans by applying two different intermediate electric fields to each said active detector, and
ii. optically reading each said active detector temperature using a predetermined wavelength light source.

14. The method of claim 12, wherein the order of said at least two measurements is interchangeable.

15. A method for addressing a designated temperature operational range in an optical readout of temperature comprising the steps of:
a. providing a detector array comprising a plurality of pixels, each said pixel associated with a serial dummy detector, each said pixel operative to provide a pixel temperature through an electric field dependent optical readout;
b. using each said dummy detector to obtain a specific readout for the temperature that lies in the center of a desired temperature range T_{center}, and
c. optically reading each said pixel.

16. The method of claim 15, wherein said step of using each said dummy detector includes calculating an electric field E* necessary to obtain said specific readout when applied to said associated dummy detector.

17. The method of claim 16, wherein said step of optically reading each said pixel includes applying an electric field to each said pixel simultaneously with applying said E* to its associated dummy detector.

18. A method for addressing a designated temperature operational range in a measurement that uses an optical readout of temperature, the optical readout performed with least one pair of a pixel and a serial dummy detector, the method comprising the steps of:
a. calculating a temperature T* of each said pixel;
b. calculating an electric field E* that adjusts a readout intensity scale to half maximum when applied to the dummy detector; and
iii. optically reading each said pixel temperature.

19. The method of claim 18, wherein said step of optically reading each pixel temperature includes applying an electric field to each pixel simultaneously with applying said E* to said associated dummy detector.
